(19) United States
(12) Patent Application Publication
(10) Pub. No.: US 2008/0083307 A1
(43) Pub. Date: Apr. 10, 2008

(54) Machine tool post having coolant distribution system

(76) Inventor: Enrico R. Giannetti, East Bernard, TX (US)

Correspondence Address: JAMES L. JACKSON;James L. Jackson, PC, 10723 Sugar Hill Dr., Houston, TX, 77042, US

(21) Appl. No.: 11/544,137

(22) Filed: Oct. 5, 2006

(51) Int. Cl. B23B 29/00

(52) U.S. Cl. 82/157

(57) ABSTRACT

A quick-setting and release tool post mechanism provides for locking of tool holders to a tool post body and incorporates a gib drive member having angulated thread flanks that impart downward and lateral forces to one or more gibs to enhance the tool holder locking activity. The tool post and tool holder each have an internal coolant supply and distribution system for supplying coolant fluid during machining. The tool post has one or more thread flank actuated tapered gibs that are actuated by manually energized rotary motion of an externally threaded gib drive member to develop thread flank induced forces that achieve locking of tool holders at selected positions on dove-tail mounts and to achieve back-lash free quick release of the tool holders from the mounts.

### BACKGROUND OF THE INVENTION

1. Field of the Invention

The present invention relates generally to machine tool posts that are mounted to machining systems and provide for support of various tool holders. More particularly the present invention concerns a tool post system having an internal coolant flow passage system that conducts coolant fluid for use in connection with a machining process. This invention also concerns a tool post mechanism having one or more screw thread actuated tapered gibs that are actuated by manually energized rotary motion of a rotatable externally threaded gib drive member to achieve locking of tool holders at selected positions. Even more particularly the present invention concerns a tool post mechanism.

2. Description of the Prior Art

Quick setting and release machine tool posts have been successfully developed as indicated by U.S. Pat. Nos. 4,126,067 and 5,124,989, both issued to Enrico R. Giannetti, the inventor of the machine tool post being the subject matter hereof.

Especially when metal parts are being machined at high speed it is necessary, to minimize accelerated wear of the machining inserts that are supported by various types of machine tools, to provide a flow of coolant medium, such as liquid coolant, air or a mixture of air and liquid coolant to the machining interface. Often, to accomplish cooling of the machining insert and moving workpiece a coolant supply tube or hose is run from a pump of a machining system and terminates at a coolant supply opening or jet nozzle that is oriented for delivering a coolant medium to the machining interface. These coolant supply tubes or hoses are not practical for high speed coolant flow because they are typically not supported so that they are often moved inadvertently or they can move during machining due to machine vibration so that coolant fluid is not properly applied to a machining interface. Also, coolant supply hoses or tubes often interfere with the machinists view of the workpiece being machined and the metal cutting operation that is taking place as the result of the machining process. Additionally, when hard metals such as stainless steel are being machined at high speed, to minimize wear of a metal cutting insert it is deemed appropriate to direct a high velocity jet of coolant to a metal cutting interface from a position immediately adjacent the cutting edge of the replaceable metal cutting insert. This high speed jet of coolant fluid also assists in clearing metal chips from the cutting interface as well as providing a cooling function for the machining interface, thus cooling both the insert and the workpiece being machined. It is also desirable to conduct a coolant medium through a coolant supply circuit of a tool post for use as desired by a machine operator or for use according to the machine set-up that exists. When a tool holder is also provided with an internal coolant flow passage system to cutting insert supporting machine tools so that one or more high speed jets of coolant are employed for cooling of a metal cutting interface. These jets of coolant are distributed via internal coolant supply and distribution passages of a tool post, tool holders and the machine tools that are mounted to the tool holders and provide support for the replaceable metal cutting inserts.

In the past, tool posts have been developed and produced having gib slots that are open at the top and bottom of a tool post body. The gib members are typically moved endwardly into the gib slots and when moved mechanically during dove-tail expansion and locking the gibs can move past the upper end of the tool post and can allow the operating handle of the tool post mechanism to be rotated sufficiently to cause a machinist to move the handle operating arm into a region where machining operations are taking place. It is desirable to provide a tool post mechanism that restricts rotation of the operating handle to an arc of movement that minimizes the potential for movement of a machinists arm into harms way.

### SUMMARY OF THE INVENTION

It is a principal feature of the present invention to provide a novel rotary, quick release and coolant distributing tool post that has the capability for operation at high speeds for machining hard metal workpieces and providing for efficient cooling of metal cutting interfaces to promote extended service life of replaceable metal cutting inserts.

It is another feature of the present invention to provide a novel rotary, quick release and coolant distributing tool post having internal coolant passage and coolant flow control devices that prevent coolant fluid flow when tool holders are not mounted to the dove-tail mounts thereof and which are responsive to the presence of tool holders in assembly therewith to permit the flow of coolant fluid through the tool post and tool support to a machine tool supported thereby.

It is another important feature of the present invention to provide a rotary quick-setting are release tool post having an externally threaded rotary actuator having thread driving relation with gib members and to provide an arrangement virtually eliminating the potential for thread back-lash when the direction of rotation of the rotary actuator is reversed for locking or unlocking the tool holders relative to the dove-tail mounts of the tool post mechanism.

Briefly, the various objects and features of the present invention are realized through the provision of a tool post body having external dove-tail mounts and defining an actuator receptacle within which is rotatably supported an externally threaded rotary gib drive member, also referred to as a rotary drive pin member, which is controllably rotated by an actuator member that is manually operated. The threads of the gib drive member are coarse and define diverging thread flanks with a curved thread bottom channel between adjacent oppositely diverging thread flanks. The angle of the thread flanks is preferably about 45°, but depending on the character of the tool post mechanism may vary from about 30° to about 60°. Gib members are retained within gib openings of the tool post body and each gib has a pair of thread engaging projections each defining a pair of oppositely angulated thread flank engaging surfaces that simultaneously engage the opposed flanks of adjacent threads to eliminate the potential for thread back-lash and to provide for immediate linear gib movement upon rotary movement of the externally threaded rotary gib drive member. As the gib drive member is rotated by the rotary actuator the flanks of the threads cause linear movement of the gibs to a downward locking position or an upward release position. Locking of a tool holder to the tool post mechanism is achieved by gib induced expansion and locking of an external dove-tail mount of the tool post mechanism within a corresponding internal dove-tail mount of a tool holder. The angulated flank surfaces of the external threads of the gib drive member develop both a downward force and a radially outward force on each of the gib members, thereby enhancing the locking capability of the tool post mechanism. Even when a gib member may be restricted against linear movement, such as when it is in engagement with the bottom of a gib opening of the tool post body, the outward force applying capability that is achieved by the angulated flank surfaces of the external threads will cause outward dove-tail expansion or locking movement of the gib member. Thus the relationship of the angulated flank surfaces of the external threads and the corresponding thread engaging relationship of the gib members creates a dual force vector activity that significantly enhances the locking capability of the tool post mechanism.

To provide for efficient coolant flow control within the internal coolant flow passage system the machine tool post has a tool post body having a coolant inlet and coolant passages extending from the coolant inlet. Within the coolant passages are provided flow control valves having open conditions to permit coolant flow and closed conditions preventing coolant flow. An inlet flow control valve is also located within the tool post body and has similar open and closed conditions for controlling the flow of coolant through the inlet opening.

Though the tool post mechanism of the present invention is applicable to a wide range of conventional tool holders, a tool holder is also provided within the scope of the present invention, having internal coolant distribution passages for conducting pressurized coolant from the coolant flow passage system of the tool post to the internal coolant flow passage system of a tool holder. This feature provides a machinist with the option to employ a conventional tool holder with the coolant supplying tool post mechanism of this invention or to select the coolant supplying tool holder of the present invention. When a coolant supplying tool holder is employed a machine tool having a coolant supply system may also be employed in supported assembly with the tool holder. The coolant passage system of the tool post and coolant supplying tool holder is designed to permit a wide range of positioning adjustment of the tool holders relative to the tool post while maintaining an efficient coolant supply capability. If desired, the machine tool itself may also have an internal coolant supply passage system terminating at jet nozzles that conduct high pressure coolant to the metal cutting interface for cooling a metal cutting insert and for removing metal chips that might otherwise tend to build up and interfere with the machining process.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an isometric illustration of a coolant distributing tool post embodying the principles of the present invention and showing a tool holder and machine tool in assembly therewith;

FIG. 2 is an exploded isometric illustration showing the various components of the coolant distributing tool post mechanism of FIG. 1;

FIG. 3 is a another isometric illustration showing the coolant distributing tool post, tool holder and insert holder of FIG. 1 from another point of view;

FIG. 4 is an isometric illustration of the coolant distributing tool post mechanism and a coolant supplying tool holder being in assembly and having parts thereof cut away and shown in section to illustrate portions of the internal coolant flow control systems thereof;

FIG. 5 is another isometric illustration of the indexing and coolant distributing tool post and tool holder assembly from a different point of view as compared with FIG. 5, with parts thereof cut away and shown in section to illustrate portions of the internal coolant flow passage system and showing valves for controlling coolant flow;

FIG. 6 is an isometric illustration of the indexing and coolant distributing tool post and tool holder assembly of FIGS. 1-3 with parts thereof cut away and shown in section to illustrate a the internal coolant flow passage system of the tool post mechanism and showing its valve control system;

FIG. 7 is a side elevational view of the tool post mechanism of FIGS. 1-6 and illustrating coolant inlet control valve actuation upon rotational movement of a rotary actuator of the quick setting tool post mechanism;

FIG. 8 is an isometric illustration of the coolant distributing tool post of FIGS. 1-3 with parts of the rotary actuator thereof cut away and shown in section to illustrate coolant inlet valve actuation upon movement of the rotary actuator;

FIG. 9 is an isometric illustration showing the bottom portion of the rotary actuator and further showing an arcuate groove with inclined ends within which is received a valve actuator pin for achieving opening movement of a coolant inlet valve of the tool post mechanism;

FIG. 10 is an isometric illustration showing a tool holder mechanism of the present invention, with parts thereof broken away for illustration of a portion of the internal and external coolant flow channels and passages thereof;

FIG. 11 is a plan view of the tool holder mechanism of FIG. 10 and by way of broken lines showing a tool receptacle and internal coolant flow passages of the tool holder;

FIG. 12 is a plan view of the tool post and tool holder of the present invention in assembly and showing a machine tool being retained in releasable assembly therewith;

FIG. 13 is an isometric illustration of one of the normally closed coolant flow control valves of the tool post mechanism of this invention;

FIG. 14 is an exploded isometric illustration showing the relationship of the various components of the coolant flow control valve of FIG. 13;

FIG. 15 is an isometric illustration of the quick-setting and coolant distributing tool post mechanism of the present invention, with parts thereof broken away and showing a dove-tail tool holder, a locking and releasing gib member and an externally threaded gib actuator of the tool post mechanism;

FIG. 16 is another isometric illustration of the rotary gib actuator of the and coolant distributing tool post and showing the force development on the gib members by the angulated flanks of the screw threads of the rotary gib actuator;

FIG. 17 is an elevational view showing one of the gib members of the quick-setting coolant distributing tool post mechanism of the present invention, particularly showing the screw thread engaging projections thereof in detail;

FIG. 18 is an isometric illustration further showing the details of the gib member geometry of FIG. 17;

FIG. 19 is a plan view of the quick-setting coolant distributing tool post of the present invention, with parts thereof broken away and showing relative angular relationships of the gib angle and tool post angle;

FIG. 20 is another isometric illustration of the rotary gib actuator of the coolant distributing tool post showing multiple pins and receptacles permitting selective positioning of the actuating handle of the rotary actuator relative to the rotary gib drive member; and

FIG. 21 is an isometric illustration showing the coolant supplying tool post mechanism of the present invention having a conventional tool holder mounted thereto and having an external coolant fluid supply tube connected in coolant receiving relation with the tool post and positioned to deliver coolant to a position near a metal cutting interface.

### DETAILED DESCRIPTION OF PREFERRED EMBODIMENT

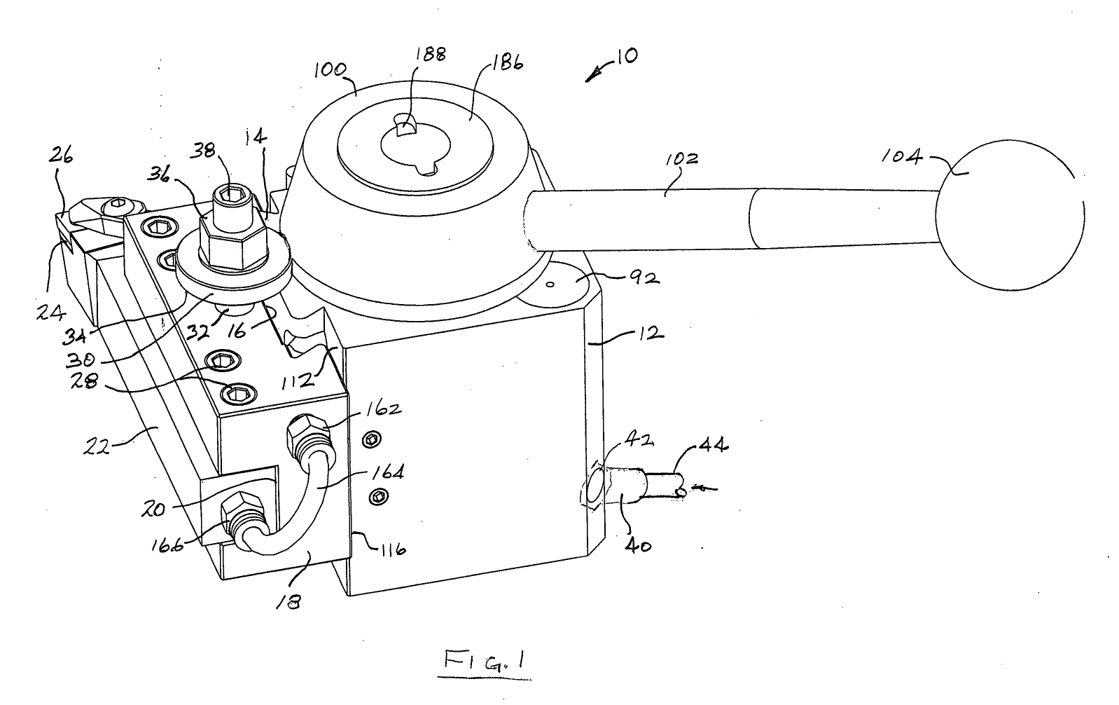

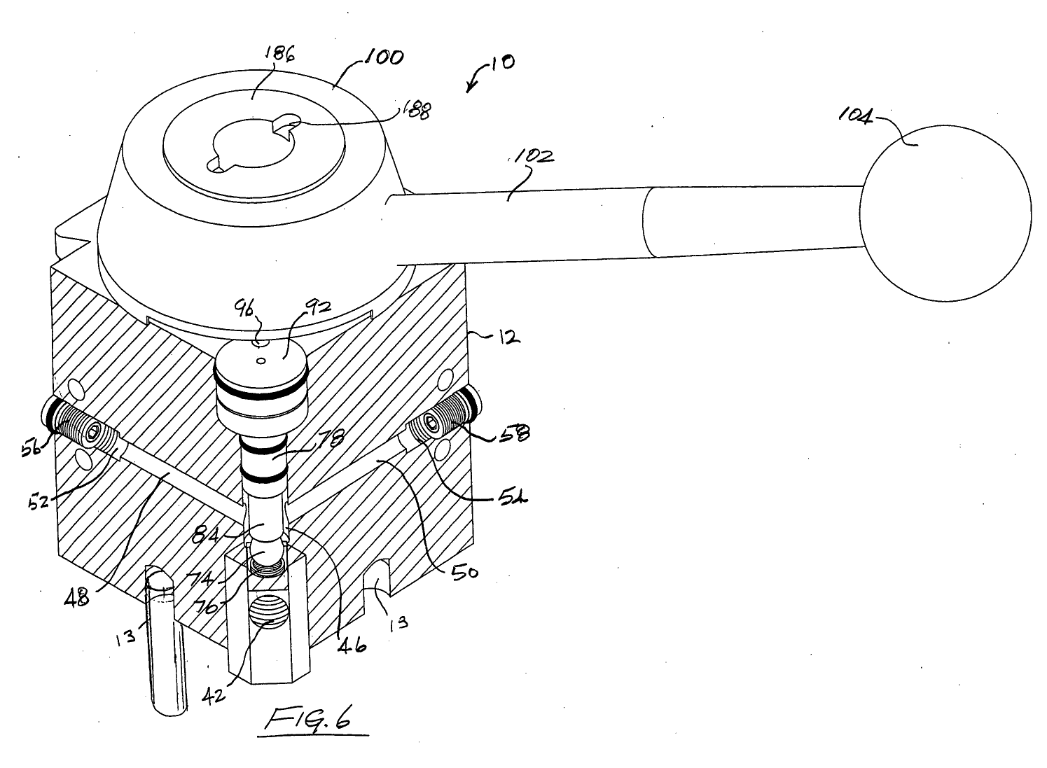

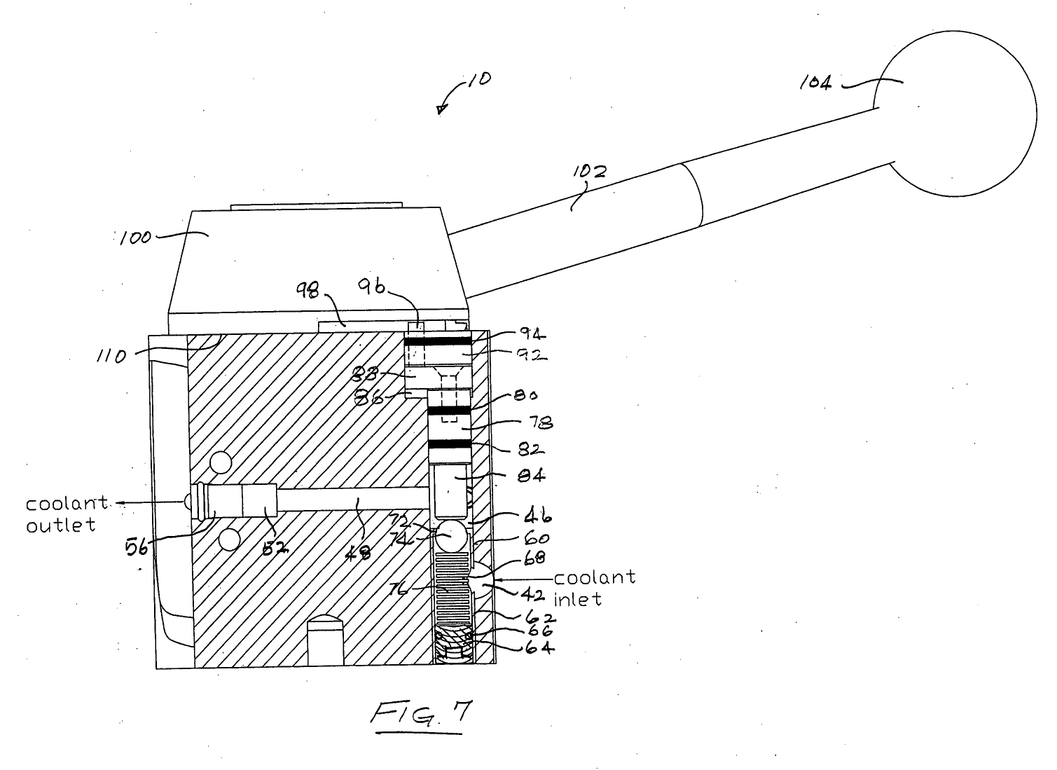

Referring now to the drawings and first to FIG. 1, a quick-setting coolant distributing machine tool post embodying the principles of the present invention is shown generally at 10 and comprises a tool post body 12 adapted for mounting to a machining system in conventional manner. The tool post body 12, as shown in FIGS. 6 and 7, defines a plurality of anti-rotation holes 13 that receive in close fitting relation a plurality of anti-rotation pins, one being shown at 15. The anti-rotation pins function to stabilize and prevent rotation of the tool post body with respect to the machining system to which it is mounted when heavy metal cuts are being machined on a workpiece. The tool post body has at least one and preferably a pair of external dove-tail mounts 14 which are adapted to be received within the internal dove-tail receptacles 16 of respective tool holders 18. Each tool holder 18 typically defines a tool slot or receptacle 20 within which received a machine tool 22 which may be of rectangular cross-section as shown in FIG. 1 or may have any other cross-sectional configuration that is suitable for a machining task. For example, in FIG. 3 the machine tool 22 is shown to have a tool shank of generally octagonal cross-sectional configuration. The machine tool may be in the form of a boring bar for internal machining and/or threading of rotating workpieces or may be designed for external machining, threading, cut-off or any other machining operation without departing from the spirit and scope of the present invention. The machine tool typically defines a cutter insert receptacle having a support seat 24 on which a replaceable metal cutting insert 26 is supported and clamped or otherwise retained. The tool holder assembly is typically provided with a plurality of set screws 28 that are manually actuated to secure the machine tool within the tool slot or receptacle 20. The set screws may be manually tightened and loosened via the use of a simple tool such as an Allen wrench to permit the machine tool to be removed from tool slot or receptacle as desired.

The position of the tool holder 18 with respect to the tool post body 12 is typically controlled by a positioning nut 30 which is threaded onto a positioning post of the tool holder 18 and defines a positioning flange or surface 34 that is disposed for positioning engagement with the upper surface of the external dove-tail mount 14 of the tool post body 12. After such tool holder positioning one or more gib members, discussed in detail below, are driven in a direction for locking of the tool holder in immovable but releasable position relative to the external dove-tail mount of the tool post body. A lock nut 36, also having threaded engagement with the threaded positioning post 32, is employed to secure the positioning nut 30 at its manually adjusted position. An actuating socket 38, such as for receiving an Allen wrench, is defined in the upper end of the threaded positioning post 32 and permits either rotation of the post or retention of the post during loosening of the lock.

As mentioned above, it is desirable to provide a quick-setting tool post mechanism having the capability for conducting a flowing coolant fluid medium from a coolant supply of a machining system and distributing the coolant medium via one or more coolant outlet openings. As is evident from FIG. 1 and other figures of the drawings, a connector fitting 40 is threaded into an internally threaded connector receptacle 42 for connection of a coolant fluid supply line 44 of a machining system pump discharge to an internal coolant distribution passage system of the tool post mechanism.

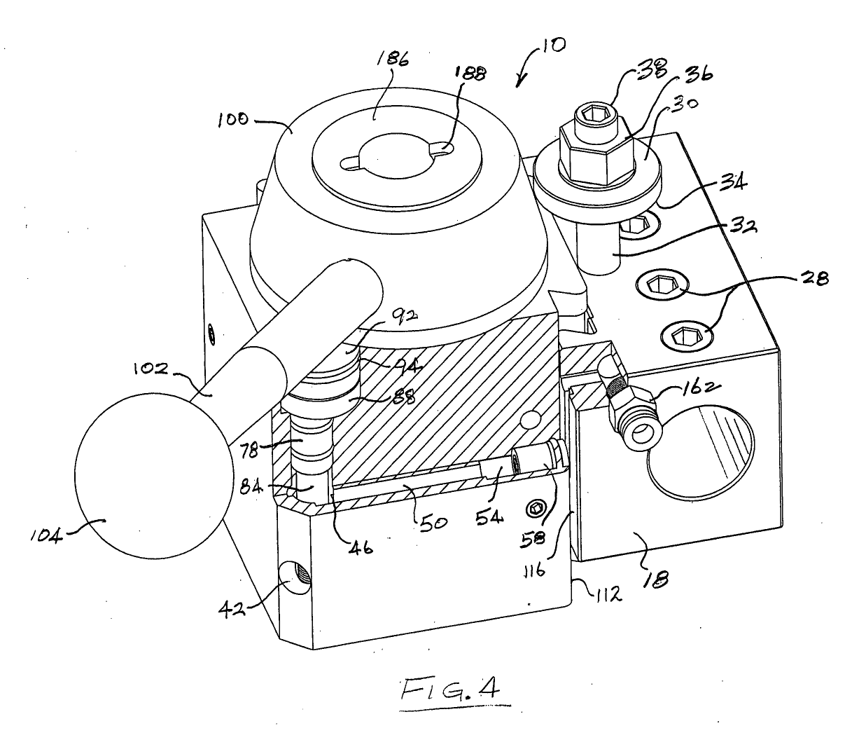

As is evident from the cut-away isometric and elevational illustrations of FIGS. 4-7, the tool post body 12 defines a generally vertical coolant supply passage 46 that is in fluid communication with the internally threaded connector receptacle 42 and defines internal lateral coolant distribution passages 48 and 50 that extend from coolant supply passage 46. The lateral passages 48 and 50 define internally threaded valve receptacles 52 and 54 each having a respective coolant flow control valve 56 and 58 secured therein by threading or by any other suitable means for retention thereof. Each of the coolant flow control valves 56 and 58 are preferably in the form of check valves and are preferably of the type shown and described in connection with FIGS. 4, 5, 13 and 14.

It is desirable to provide the coolant fluid supply inlet of the tool post body 12 with a valve control so that the supply of pressurized coolant medium can be shut off or discontinued when the tool post mechanism has been manually operated to its release position. This feature is accomplished by a coolant fluid inlet supply valve 60 in the form of a check valve capsule that is secured within a portion of the generally vertical coolant supply passage 46 as is evident from FIG. 7. The valve capsule is comprised of a tubular valve housing 62 which is secured within the passage 46 by means of a plug member 64 or by a closed lower end wall of the passage that is defined by the lower portion of the tool post body. The plug member defines a circular seal groove within which is received an O-ring type seal member 66 The valve housing 62 defines an inlet opening 68 which is in communication with the inlet passage 46 and with the lateral passages 48 and 50. The tubular valve housing 62 has an upper end wall 70 that defines a circular valve seat 72 which is engaged by a valve ball 74 in the closed position of the inlet check valve. A helical type compression spring member 76 serves to continuously urge the valve ball toward its closed position with respect to the circular valve seat 72 and in absence of any other force serves to force the valve ball to its seated and closed position.

A portion of the generally vertical coolant supply passage 46 defines a valve actuator receptacle within which is moveably positioned a valve actuator member 78 which is sealed to the passage wall by a pair of spaced O-ring seal members 80 and 82. Depending from the valve actuator 78 is an integral valve actuating pin 84 having clearance with respect to the internal surface of the passage 46 so that a flow passage is defined externally of the valve actuating pin. The integral valve actuating pin member 84 is disposed for engagement with the valve ball 74 and upon downward movement from the position shown in FIG. 7 will unseat the valve ball from its seat, thus opening the valve and permitting coolant fluid to flow from the inlet to the lateral coolant supply passages 48 and 50. At the upper portion of the generally vertical coolant supply passage 46 there is provided an enlarged chamber 86 containing a piston-like plate member 88 which is secured to the valve actuator 78 by means of a retainer screw 90, being shown in broken line. Another piston-like plate member 92, being sealed to the chamber wall by an O-ring type seal member 94, is free to be rotated and moved downwardly by an actuator pin member 96 which is seated within a pin receptacle of the piston-like plate member 92. The upper portion of the pin member 96 projects from the piston-like plate member 92 and is received within an arcuate slot 98 that is provided within the underside of a rotary tool post actuator member 100. The rotary tool post actuator member 100 is provided with an operating handle 102 having a handle knob 104 at the free end thereof of facilitate ease of manual rotation of the tool post actuator member. The operating handle 102 is provided with a threaded end which is threaded into an internally threaded receptacle of the rotary tool post actuator member; however any other means for handle connection, including an integral handle may be employed without departing from the spirit and scope of the present invention.

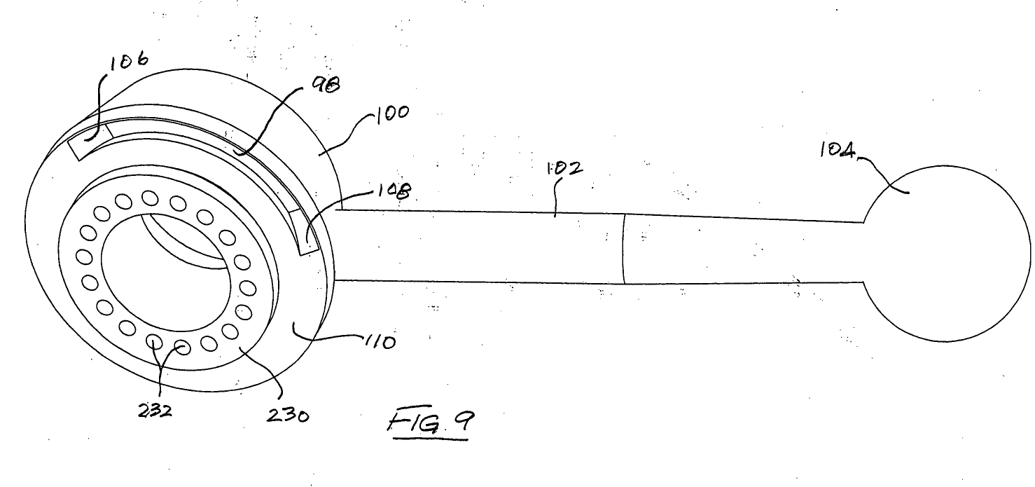

The arcuate slot 98 in the under-side of the rotary tool post actuator member 100 is best shown in FIG. 9 and defines inclined slot end surfaces 106 and 108 that each extend from a bottom surface of the arcuate slot and intersect a circular generally planar surface 110 that defines a valve positioning control surface. As the rotary tool post actuator member 100 is rotated by manual movement of the operating handle 102 the pin member 96 will be at its upward position within the arcuate slot. This condition permits the integral valve actuating pin 84 and the valve ball 74 to be located at their upper positions, permitting the valve ball to be seated on the circular valve seat 72 and closing the valve and preventing coolant fluid flow to the lateral passages 48 and 50. When the rotary tool post actuator member 100 has been manually rotated sufficiently to bring the inclined slot end surfaces into engagement with the pin member 96, any further rotation of the actuator member 100 will cause a camming action to take place between either slot end surface and the pin member 96, moving the pin member downwardly. This activity drives the members 88, 78 and 84 downward, causing the actuator pin member 84 to unseat the valve ball 74 from its circular seat 72, thus opening the check valve against the mechanical bias of its compression spring 76. After the pin member 96 has cleared either of the inclined ends of the arcuate slot it will be maintained in its downward or valve open position by the circular generally planar surface 110. Thus, at the locked or released position of the quick-setting indexing and coolant distributing machine tool post the coolant inlet valve will be open, permitting flow of pressurized coolant fluid from the coolant inlet passage to the lateral passages. Only when the arcuate slot or the tapered end surfaces are in registry with the pin member 96 will the inlet coolant fluid inlet supply valve 60 be closed to prevent the flow of coolant into the tool post body. This closed inlet valve condition occurs when the actuator member is being moved between its locked and release positions. Consequently, when the tool post mechanism is unlocked, such as for replacement or adjustment of a tool holder coolant flow through any of the passages of the tool post body or tool holder cannot occur and coolant spills will be prevented. Operating personnel can loosen a tool holder by rotating the actuator member 100 without paying any particular attention to the status of the coolant supply system of the tool post body and tool holder since inlet valve closure occurs automatically when tool post unlocking occurs.

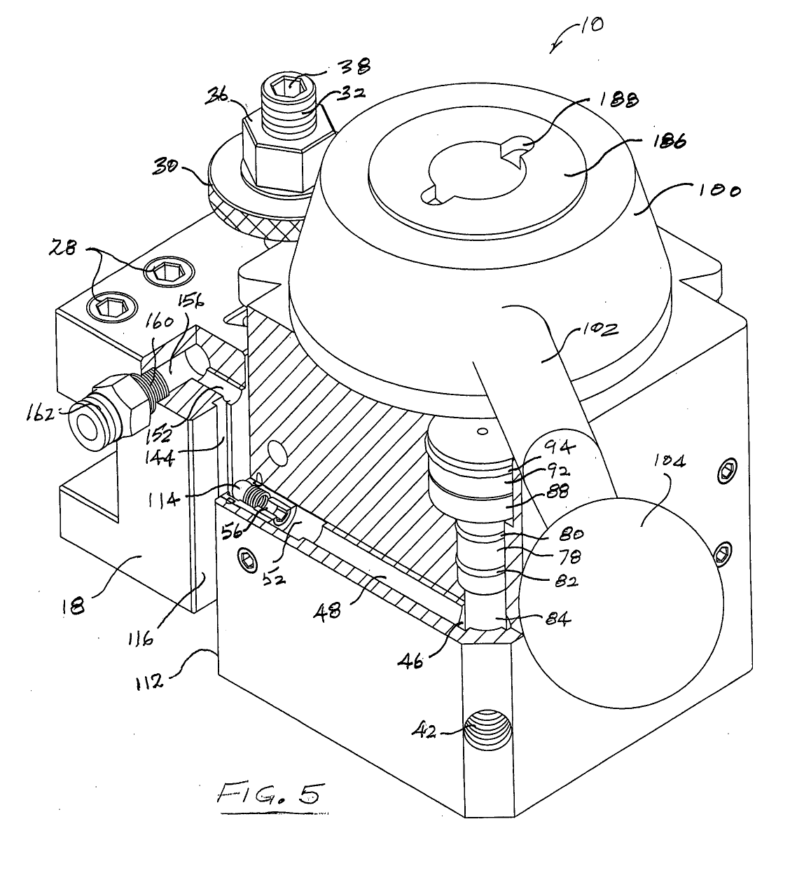

As is evident from FIGS. 1 and 5, each of the external or male dove-tail mounts 14 define at least one substantially planar surface 112. The coolant flow control valves 56 and 58, preferably each being check valves, are positioned such that the ball or other check valve member 114 projects beyond the surface 112 and in position to be contacted and moved by a corresponding generally planar surface or co-planar surfaces 116 of the tool holder 18. Thus, when the tool holder 18 is positioned in assembly with the dove-tail mount of the tool post body 10 and is tightened or locked by the gib actuated locking mechanism, the coolant flow control valves 56 and 58 will be unseated and thus opened to permit coolant fluid flow from the coolant fluid circuits of the tool post body to the coolant fluid circuits of the tool holder. In the event a conventional tool holder is employed, not having an internal coolant flow passage system, the coolant flow control check valves 56 and 58 may be replaced by closure plugs and a coolant supply tube may be connected in communication with the internal coolant flow passage system of the tool post body 12.

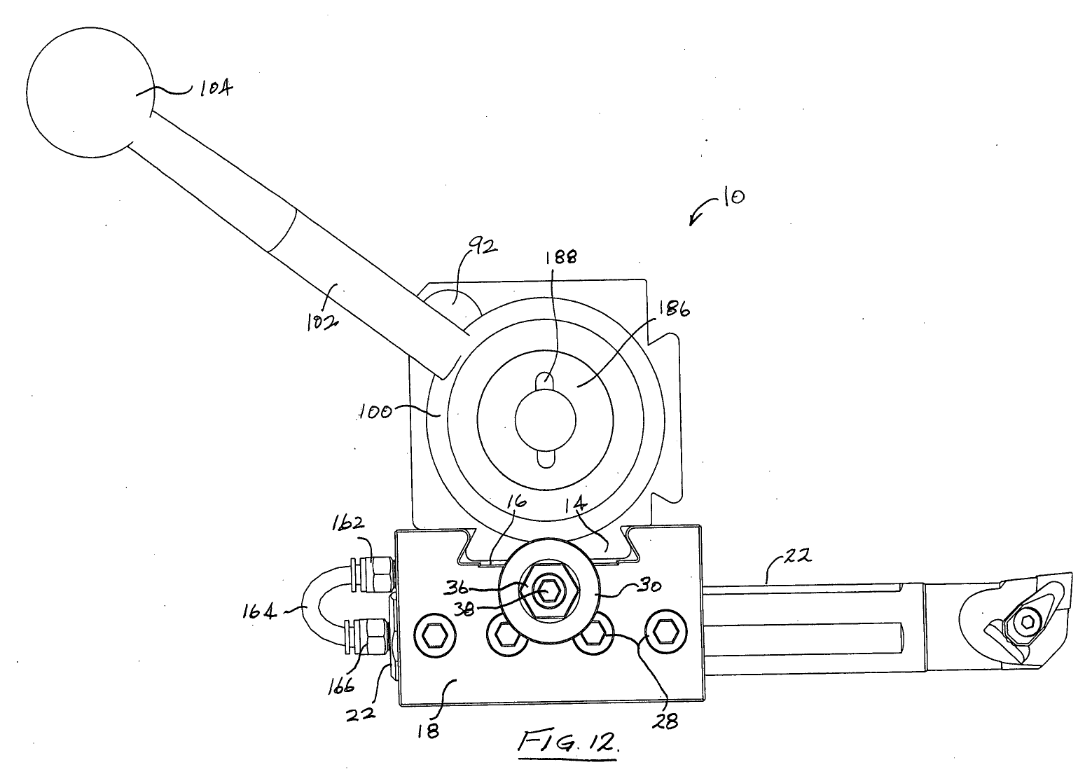

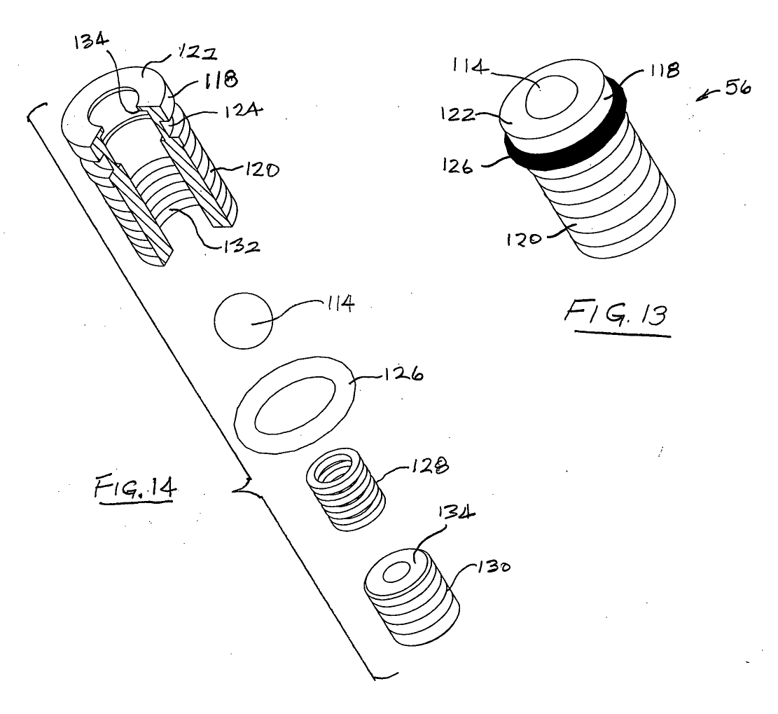

With reference to FIGS. 13 and 14, the coolant fluid flow control valves 56 and 58 may conveniently take the form of ball type check valves shown generally at 56. As shown by the exploded sectioned view of FIG. 14, the coolant fluid flow control valves have a tubular valve body 118 defining an externally threaded section 120 enabling the valve body to be threaded into an internally threaded valve receptacle 52 or 54 as shown in FIG. 6. When threaded to its full extent within the internally threaded valve receptacle a generally circular planar end surface 122 will be flush or essentially coplanar with the generally planar surface 112. The tubular valve body 118 also defines a circular external seal groove 124 within which is received an O-ring type sealing member 126 that achieves sealing of the coolant fluid flow control valve with respect to the valve receptacle 52 or 54 of the tool post body structure. A compression spring 128 is retained within the valve body 118 by means of an externally threaded retainer plug member 130 which is received within an internally threaded section 132 of the valve body. The upper end of the retainer plug member 130 defines a circular spring seat which provides support for the lower end of the compression spring. The upper end of the compression spring is disposed in force transmitting engagement with the lower portion of the valve ball 114 and urges the valve ball toward its seating engagement with an annular valve seat 134 that is defined by an inwardly extending circular flange that defines a portion of the generally circular planar end surface 122 of the valve body. Normally the valve ball members of the check valves will project beyond the planar surface or surfaces 112. When a tool holder is mounted to the dove-tail mount of the tool post body and tightened, the planar surface or surfaces 116 of the tool holder will engage the ball or other check valve member and move the valve member to its open position, thus opening the coolant circuit and permitting coolant to flow from the tool post to the tool holder.

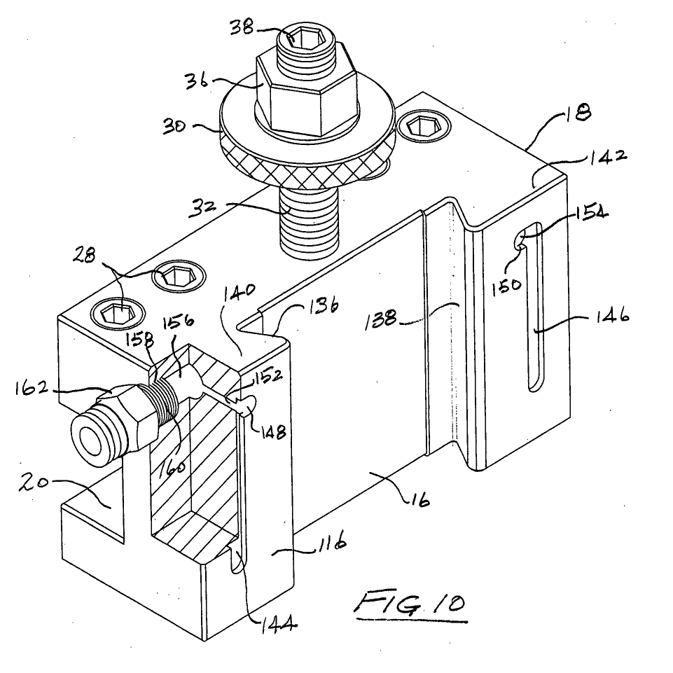

It should be borne in mind that a tool holder having a coolant flow circuit of the general nature that is shown in FIGS. 10 and 11 may be employed in machining set-ups when the tool post to which it is mounted may not be provided with a corresponding internal coolant circuit. In this case, a coolant supply conduit may be run from the machining system and may be connected to the tool holder mechanism by means of a suitable conduit connector such as is shown at 162 in FIGS. 10 and 11. Obviously, the coolant inlet openings 148 and 150 and the corresponding elongate coolant slots 144 and 146 would not be needed, and would be plugged or otherwise closed if the tool holders were to be mounted to either coolant supplying or non-coolant supplying tool post systems. This feature would permit coolant supplying tool holders to be employed in connection with a wide range of tool post systems.

As is evident from FIGS. 1, 3, 4, 5 and 10 of the Drawings, the tool receptacle may simply be defined as a slot (FIGS. 1, 5 and 10) or it may take the form of a bore or through passage of the tool post body 12 (FIGS. 3 and 4) depending on the type of machine tool that is supported therein. For example, a boring bar, which typically has an octagonal cross-sectional configuration, is shown to be secured within a tool receptacle in the form of a through passage of the tool holder. This feature permits the connection of a coolant fluid supply conduit to a supply passage that extends longitudinally through a boring bar or other machine tool. A coolant fluid supply conduit may also be connected to a supply passage that is provided only in the head portion of a machine tool. And as shown in FIG. 1 a coolant supply transition conduit may be employed to conduct coolant fluid from the coolant supply circuit of a tool holder to a longitudinal coolant supply passage that extends through the shank of a machine tool.

Referring to FIG. 10 a tool holder 18 is shown which defines an internal dove-tail receptacle having undercut, angulated dove-tail shoulders 136 and 138 which are engaged by oppositely inclined external shoulder surfaces of a dove-tail mount. The tool holder defines spaced projections 140 and 142 that define the generally planar surfaces 116, mentioned above, which are disposed in co-planar relation with one another. Within the spaced projections 140 and 142 are formed elongate fluid channels 144 and 146 that have an offset upper end portion 148 and 150 that are each in fluid communication with coolant passages 152 and 154. When the planar surfaces 116 are disposed in face to face engagement with the corresponding planar surfaces 112 of the tool post body 12 the check type coolant flow control valves 156 and 158 will be unseated or opened by the planar surfaces and will permit coolant to flow into the closed elongate channels 144 and 146 and thence into the coolant passages 152 and 154 of the tool holder. As is shown by the cut-away portion of FIG. 10 the coolant passages are in communication with a passage 156 having an internally threaded portion 158 that receives the externally threaded section 160 of a coolant supply connector fitting 162. If desired, from the coolant supply connector fitting 162 a supply conduit 164 of U-shaped configuration is employed to establish fluid communication of the passage of the fitting 162 with another coolant supply connector fitting 166 that is in fluid communication with the longitudinal coolant supply passage of a machine tool as shown in FIGS. 1 and 3.

As mentioned above, it is desirable to provide a tool post mechanism having a quick-setting and release capability and having mechanically actuated gib members that are actuated by linear and lateral force vectors for efficient locking and releasing with respect to tool holder devices. To achieve this feature, the tool post body 12 defines an actuator receptacle 168 of generally cylindrical configuration and has gib openings 170 and 172 through the wall structure thereof within which gib members 174 and 176 are retained in linearly guided relation. The gib openings 170 and 172 each have a length that exceeds the length of the gib members, thus permitting the gib members to be moved linearly within the limits of the lengths of the gib openings. The tool post body 12 defines a bottom wall 178 within which an internally threaded opening 180 is defined. A tubular actuator guide member 182 is positioned within the actuator receptacle 168 and has a lower externally threaded end portion 184 which is received in threaded engagement with the internally threaded opening 180 The tubular actuator guide member 182 is provided with a retainer head 186 that secures the rotary actuator member 100 in rotatable assembly with the upper portion of the tool post body. The retainer head carries a circular O-ring type seal member 185 which establishes a seal with the cylindrical internal surface 101 of the rotary actuator member 100 Spanner or other wrench openings or recesses 188 permit a tool to be employed for securing the actuator member, a threaded gib drive member 190, a bearing member 192 and one or more circular O-ring type sealing members 194 in assembly with the tool post body. The rotary tool post actuator member 100 defines a circular internal upwardly facing shoulder surface 193 on which the bearing member 192 is seated. A retainer flange provided by the outer circumference of the retainer head 186 engages the bearing and serves to retain it in place. Gib retainer members 187 are positioned within gib openings of the tool post body 12 and have inner ends that extend from the inner portions of the gib openings and engage retainer and guide slots or recesses 177 of the gib members and serve to maintain the gib members in moveable and captured position within the gib openings, Each gib retainer member is urged toward a gib members by a compression spring 189 and by a set screw or other retainer member 191 which is threaded into a threaded part of the opening of the tool post body and is secured by any suitable thread seizing material. The gib retainer members prevent the gibs from falling out of the gib openings in the event the tool post should be oriented with one of the gib openings facing downwardly. The gib retainer members, engaging the gib members at spaced locations, also function to stabilize and main proper orientation of the gibs with respect to the tool post body especially during upward and downward unlocking and locking movement of the gib members as will become clear from the discussion below.

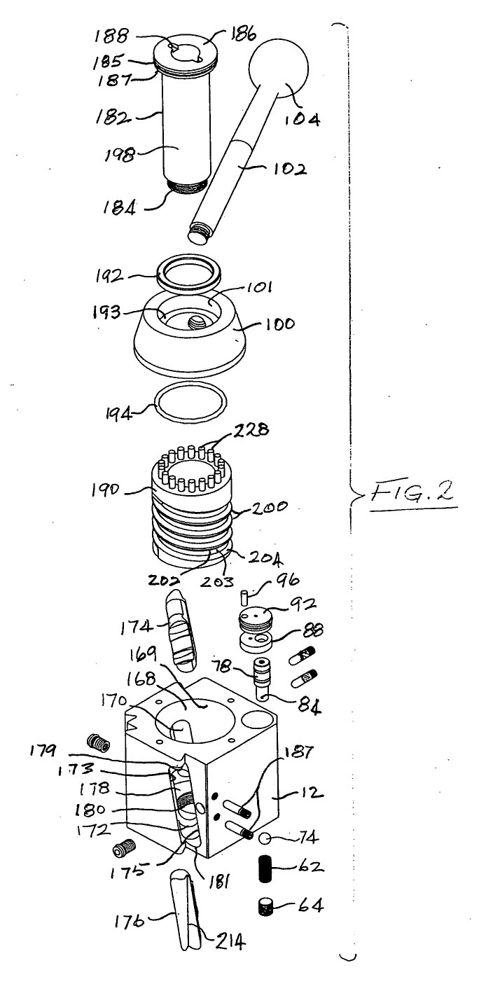

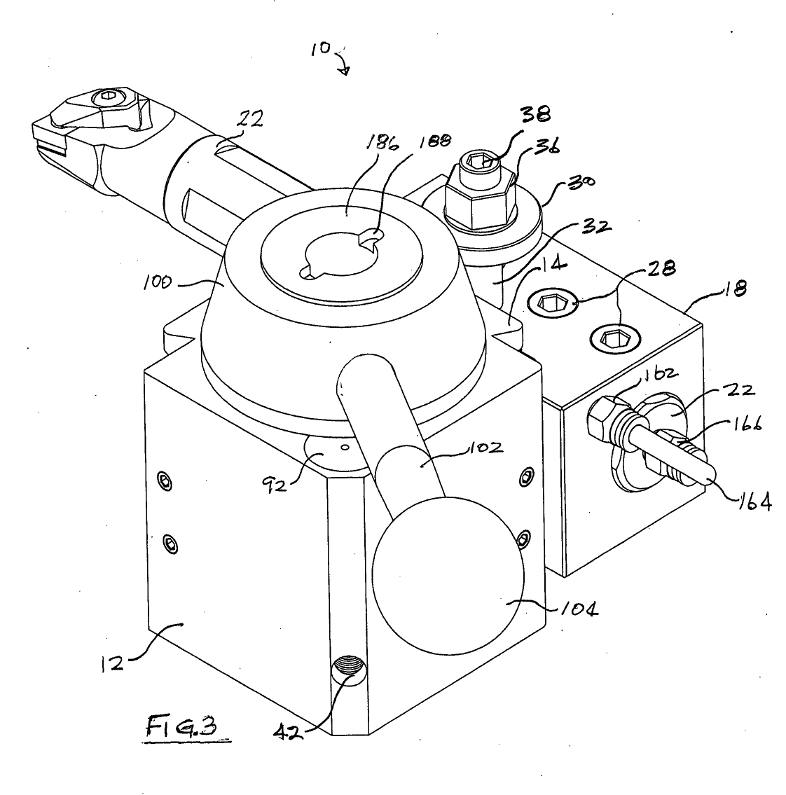

As is evident from FIG. 2, each of the gib openings 187 is defined in part by angulated side or lateral surfaces, one of which is a guide surface 173 having guiding engagement with a gib member and the other lateral surface being a locking or wedging surface 175 that provides lateral support for a gib member that has moved into wedging or locking engagement with the undercut dove-tail mount surface of a tool holder and is being tightened to its locking condition. The lateral guide and locking surface are each inclined with respect to the vertical. For example, the inclination of these guide surfaces may be in the order of 7.5° from the vertical, though they may be of any angle that is suitable to the manufacturer and user. As a gib member is driven downwardly toward its locking position the angulated guide surface reacts in cam-like manner with the gib member, causing it to move simultaneously outwardly and downwardly toward its locking position. As locking activity progresses the gib member and the lateral locking or wedging surface 175 will interact to prevent further lateral gib movement while outward or expansion movement of the gib locking surface is taking place. The locking activity also causes frictional engagement of the gib member with the lateral locking or wedging surface 175. This feature causes frictional resistance to sliding gib movement against the lateral locking or wedging surface 175. This feature also permits thread induced lateral locking movement of the gib members as explained below.

The gib openings of the tool post body 12 are defined in part by tool post body structure both above and below the gib openings which exist because the gib openings 172 each have curved end surfaces 177 and 179 that correspond to the curved upper and lower end configuration of the gib members. These curved end surfaces of the gib openings function as stop surfaces defining the upper and lower extent of gib movement during locking and unlocking activity. Due to the use of gib openings having upper and lower ends, the tool post body 12 is not partially divided by gib slots. Thus, the tool post body of the present invention is an integral, generally rectangular and very rigid structure that maintains its structural integrity even when very heavy machining cuts are being taken. The warping and body yielding by tool posts having gib slots is significantly resisted by the tool post body structure of the present invention.

The closed upper and lower ends 179 and 181 of the gib openings 172 also provide a safety function by ensuring that actuator handle rotation during tool holder unlocking movement is stopped at a position where the hands and arms of the machinist do not move with the actuator handle into a danger zone near the site of the metal cutting operation or the rotating workpiece. As tool holder unlocking occurs, such as by counter-clockwise rotation of the actuator handle, the gib member or members will move upwardly. As explained above, many of the commercially available tool posts have gib slots that are open at the top and bottom of a tool post body. Consequently, upward movement of the gibs is not restricted, so the actuator handle can be rotated much further as compared with the present invention, thereby allowing the hand and arm of the user to move into the danger zone. The closed end surfaces of the gib openings of the present invention serve as positive stops which limit upward unlocking movement of the gibs and consequent tool post handle rotation to a safe position that is selected by the user. The features shown in FIG. 20 and discussed in detail below permit a user to selectively position the operating handle so that full opening rotation of the operating handle will permit the hands of the user to remain clear of the danger zone of a machining operation.

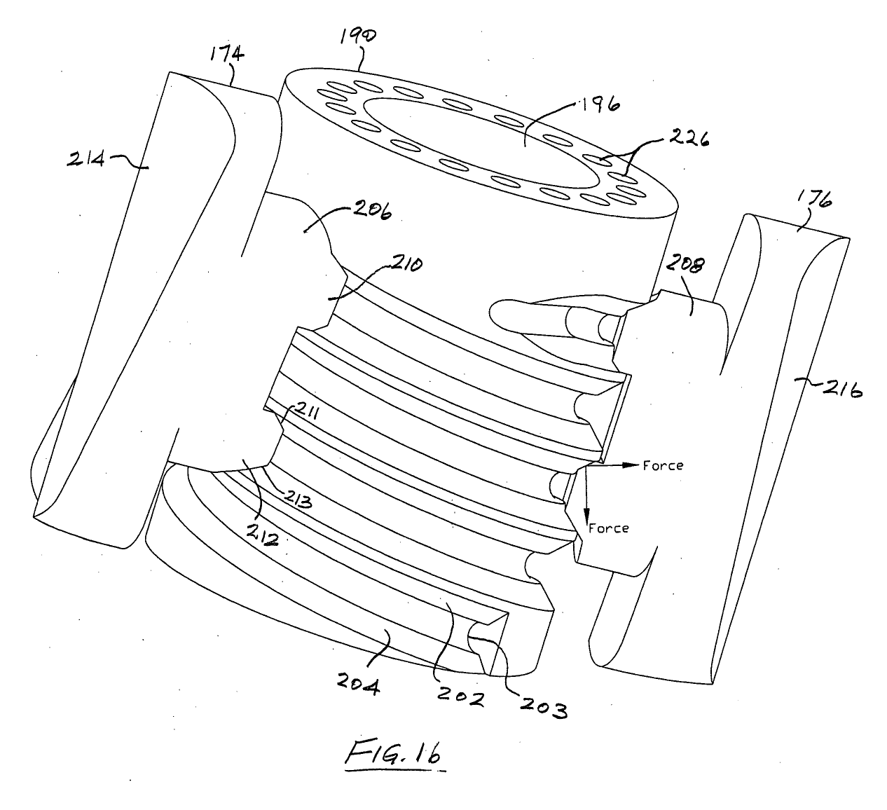

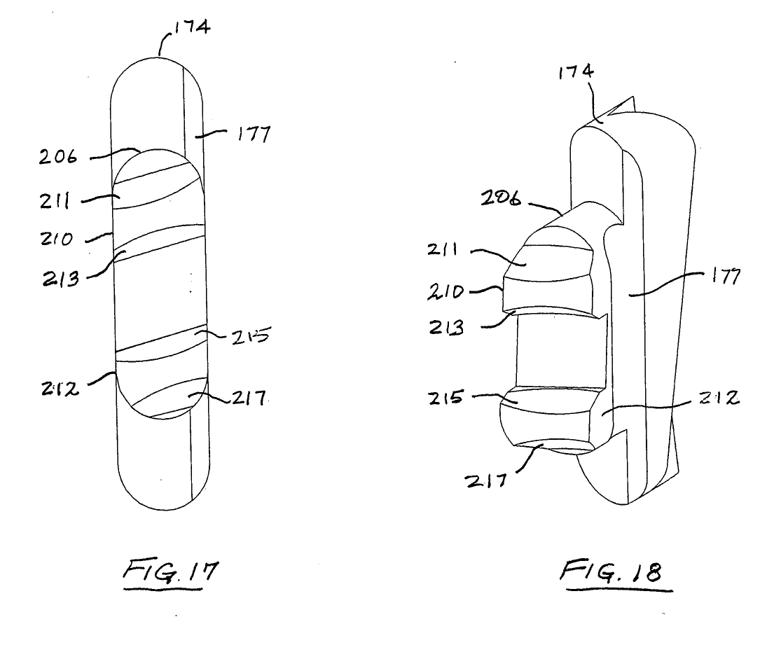

As shown in detail in FIGS. 16 and 17, the externally threaded gib drive member 190 defines a generally cylindrical central opening 196 through which a cylindrical surface portion 198 of the tubular actuator guide member 182 extends to provide efficient rotatable and stabilized support for the threaded gib drive screw member within the actuator receptacle 168 of the tool post body 12. The threaded gib drive screw member 190 defines a coarse helical thread 200 having diverging upper and lower thread flanks 202 and 204. The flank angles of the threads is preferably about 45° but may have flank angles in the range of from about 30° to about 60°. The flank angles cause the development of linear and lateral force vectors of the gib members thus causing the gib members to move both linearly and laterally to result in dove-tail expansion and locking. The helical thread groove between adjacent thread flanks is defined in part by a relief thread bottom 203 of curved cross-sectional configuration which intersects both of the diverging thread flanks.

Each of the gib members 174 and 176 defines laterally extending projections 206 and 208. Projection 206 defines a pair of spaced thread flank engaging members 210 and 212. thread flank engaging member 210 defines a pair of oppositely tapered thread flank engaging surfaces 211 and 213 each having an angle of taper corresponding to the angle of the respective flank angle engaged thereby. The thread flank engaging members 212 define oppositely tapered thread flank engaging surfaces 215 and 217 as shown in FIG. 16-18 which also have surface to surface force receiving engagement with the respective oppositely tapered flanks of adjacent threads. The oppositely tapered thread flank engaging surfaces of each laterally extending projection are preferably oriented at the same angles as the angles of the thread flank surfaces 202 and 204 and are angularly oriented at the twist geometry of the thread of the threaded gib drive member 190. This feature causes all of thread flank engaging surfaces of the laterally extending projections 206 and 208 to simultaneously engage a respective flank surface of the thread of the rotatable gib drive member 190. This simultaneous flank surface engagement virtually eliminates the potential for thread back-lash so that rotary movement of the gib drive member 190 in either of the locking or unlocking directions causes immediate linear movement of the gib members, either downwardly for locking or upwardly for unlocking. Thus when reversal of the direction of rotation of the threaded gib drive screw member 190 occurs, such as during unlocking rotation from the gib locking condition, virtually no thread back-lash is experienced. Rotational movement of the threaded gib drive screw member 190 causes substantially instantaneous linear movement of the gib members. This feature permits efficient and crisp locking and unlocking of the dove-tail mounts of the tool post mechanism.

As shown by a force arrow diagram in FIG. 16, rotational movement of the externally threaded gib drive member 190 in the locking direction, which occurs upon clockwise rotation of the gib drive member by the rotary actuator 100, causes the development of simultaneous downward and lateral or outward force vectors acting on the gib members 174 and 176 as shown by the force vector arrows. Under circumstances where linear movement of the gib members is restrained or prevented, such as due to the development of frictional resistance due to wedging or camming activity of the gib members or due to a gib member engaging a gib stop surface at the upper or lower end of a gib opening or window of the tool post body, the outward force vector will become predominant and will move the gib member outwardly. This outward gib movement, even when linear movement of the gib is prevented, will cause expansion and positive locking of the external dove-tail mount of the tool post mechanism with respect to the internal dove-tail mount of a tool holder. This feature permits effective locking and unlocking movement of the gib members of the tool post mechanism even when linear movement of the gib members is restrained or prevented.

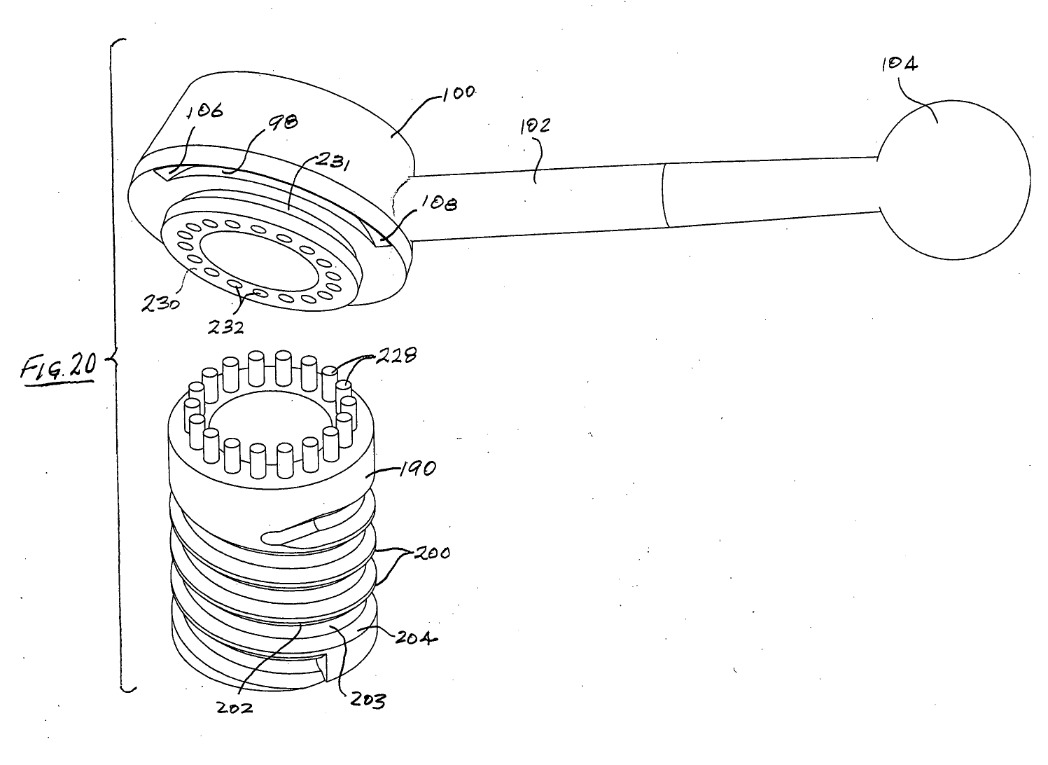

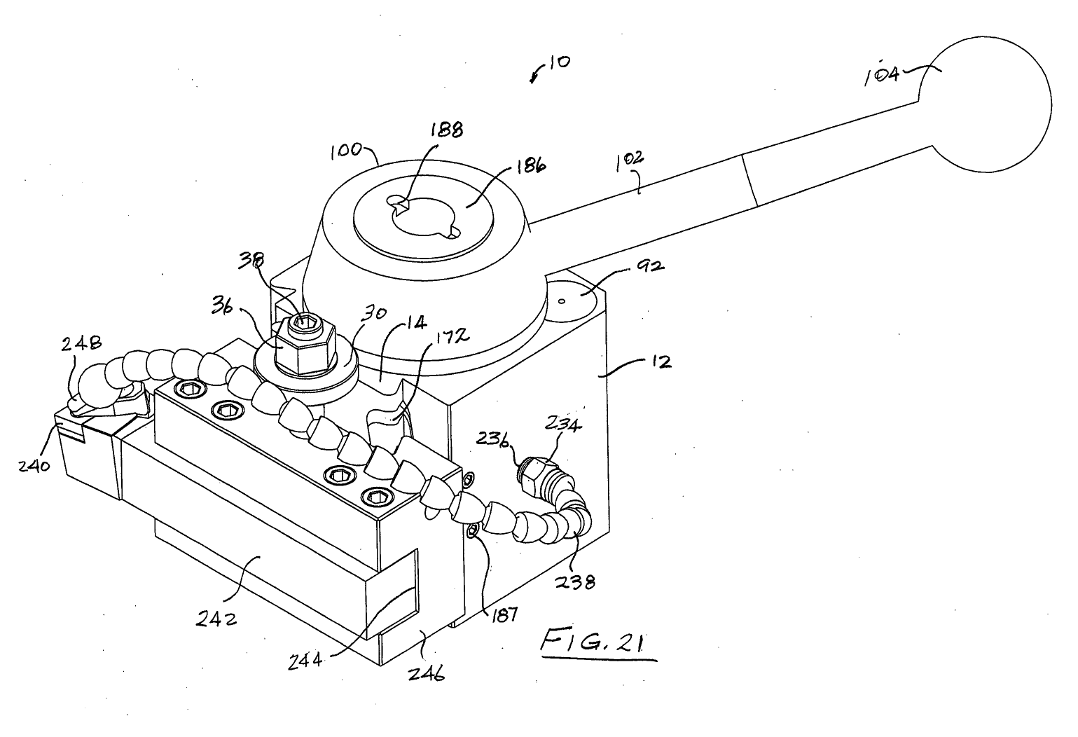

Each of the gib members 174 and 176 is provided with a tapered cam surface, shown at 214 and 216 and as best shown in FIG. 19 has side surfaces 218 and 220 that have guided engagement with guide surfaces 222 and 224 of the tool post body. Thus, as the gib members are driven downwardly by rotation of the threaded gib drive member 190 the angulated or tapered cam surface 214 or 217, as the case may be, achieve expansion of the undercut or angulated surface of the dove-tail mount, thereby establishing locking relation within the dove-tail recess of a tool holder. This feature locks the tool holder in place with respect to the tool post body. Release of the tool holder from this locked relationship is accomplished simply by rotating the actuator and thus the threaded gib drive member 190 in the reverse direction thereby moving the gib member upwardly. Since the fit of the spaced thread flank engaging members 210 and 212 with both of the diverging thread flanks and with respect to both of the spaced thread sections is maintained at all times, no thread/gib back-lash exists. Opposite rotation of the threaded gib drive member 190 will immediately move the gib members simultaneously upwardly, causing immediate loosening of the locked condition and minimizing any potential for binding of the dove-tail connection of the tool holder and the tool post. Movement of the gib members to their locking positions and to their release positions is achieved not only by linear movement of the gib members by the rotatable gib drive member but also by the thread geometry of the rotatable externally threaded gib drive member 190. As explained above, the external thread of the gib drive member have thread flanks preferably having flank angles of about 45° though the flank angles may be within a range of from about 30° to about 60°. Additionally the thread grooves between the flank angles are relieved, i.e., sufficiently deep that the oppositely tapered thread flank engaging surfaces can engage only the thread flank surfaces. The flank angles cause the development of force vectors acting downwardly and outwardly on the gib members as they are moved toward their locking positions by rotation of the gib drive member. When the gib member encounters frictional resistance to downward locking movement or when the gib members reach the downward limit of their travel within the gib openings of the tool post body, the outward or lateral force vector become predominant and causes effective lateral expansion and locking movement of the gib member, securely locking a tool holder in immovable relation with the tool post body. The greater the rotational force that is applied to the rotary actuator 100 by application of manual force on the actuator handle 102 the greater will be the locking force due to the outward or lateral force vector that is imparted by the thread flanks to the gib member. This lateral locking force of the gib member is directly proportional to the manual rotational force that is applied to the actuator handle.

It is important to note that the angulated or tapered cam surface 214 or 217 of the gib member has an included angle α with respect to the generally planar surface 112 of the tool post body as shown in FIG. 19. Conversely, the gib guide surface 222 has an included angle β with respect to the generally planar surface 112. For efficient gib induced locking of a tool holder to a tool post body to be achieved, it is necessary that the included angle α always be greater than the included angle β. Either of the included angles α and β may be greater or lesser than is shown in FIG. 19 as long as the included angle α is always greater than the included angle β.

At least the thread flank engaging surface and preferably the entire surface are of the gib members and the thread surfaces of the rotatable gib drive member 190 are protected by a surface hardening process known as Ion-Nitride. Ion Nitride hardening of these engaging surfaces significantly minimizes the potential for wear and significantly enhances the service life of quick-setting and release type tool posts. Though Ion Nitride surface hardening is deemed preferable for these types of tool posts, other surface hardening processes may be employed as well to minimize wear and thus extend the effective service life of tool posts.

It should be noted and appreciated that the angle of the guide surface 222 with respect to the planar surface 112 of the tool post body, shown diagrammatically as “β”, in FIG. 17 may be different as compared with the angle of inclination of the tapered cam surface 214, which is shown diagrammatically as “α”. The relationships of these angles can be changed to other relative angles according to the preference of machining personnel.

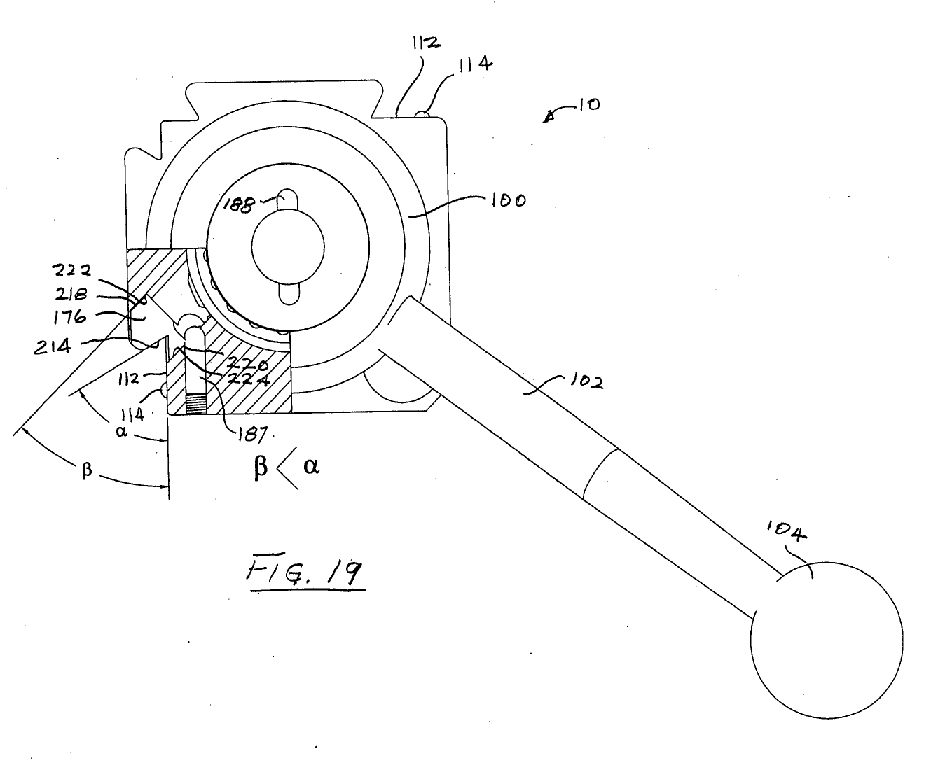

During some machining operations and when the tool post mechanism of the present invention is used with a variety of machining systems, the operating handle of the tool post mechanism may cause interference with other machine components or it may not be free for the necessary rotation for locking and unlocking of the dove-tail mount connections. Also, positioning of the operating handle of the tool post during tool post unlocking may cause the hand and arm of a user to move into the danger zone, near the metal cutting interface or near a rotating workpiece, potentially subjecting the user to a dangerous condition. Accordingly, to overcome these disadvantages, as shown in FIG. 17 the threaded gib drive screw member 190 is provided at its upper end with a plurality of pin holes 226 each having orienting pins 228 fixed therein as shown in FIG. 18. Correspondingly, the rotary tool post actuator member 100 has a depending generally circular flange 230 which defines a plurality of orienting holes 232 that receive the orienting pins when the actuator is assembled to the tool post mechanism. This feature provides the user of the tool post mechanism to change the relative position of the actuator so that the handle always has freedom for substantially 90° of rotational movement without interfering with any other components of the machining system. The depending generally circular flange 230 projects into the upper portion of the generally cylindrical actuator receptacle 168 and defines a circular seal groove 231 within which the circular seal member 194 is received. The seal 194 establishes sealing engagement with the internal cylindrical surface 169 that defines the generally cylindrical actuator receptacle 168, thereby preventing foreign matter from entering the tool post mechanism and ensuring the retention of lubricant within the tool post body for continuous lubrication of the moveable components thereof. This improvement permits the stopping position of tool post unlocking rotation at a handle position that is clear of the machining operation and the rotating workpiece being machined. The tool post is actuated to its full unlocked position, with the gib members in engagement with the upper stop surfaces of the gib openings. The actuating handle is then removed and oriented to a safe positioned, typically in substantial alignment with the ways of the machining system, and then secured in this position. Thereafter which unlocking the tool post that operating handle can be moved only to this safe position and no further. This is a significant advantage for machining personnel.

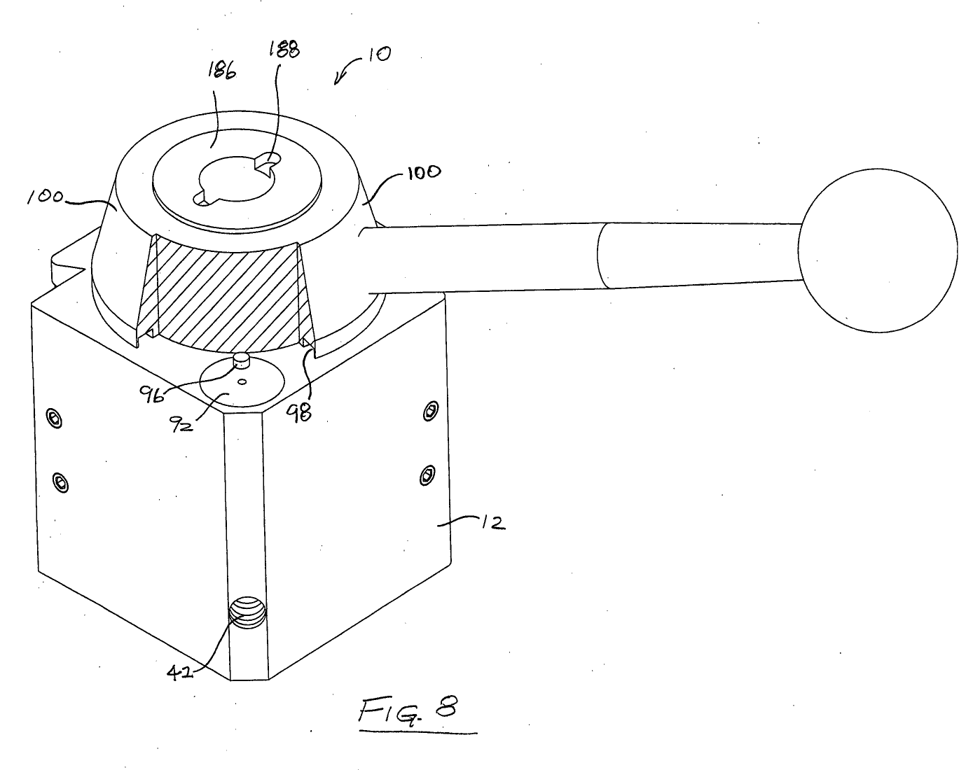

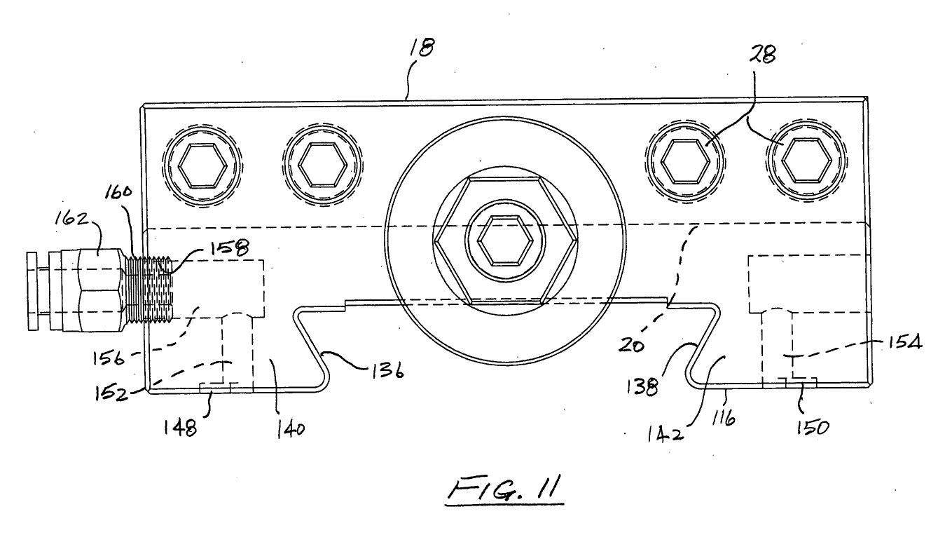

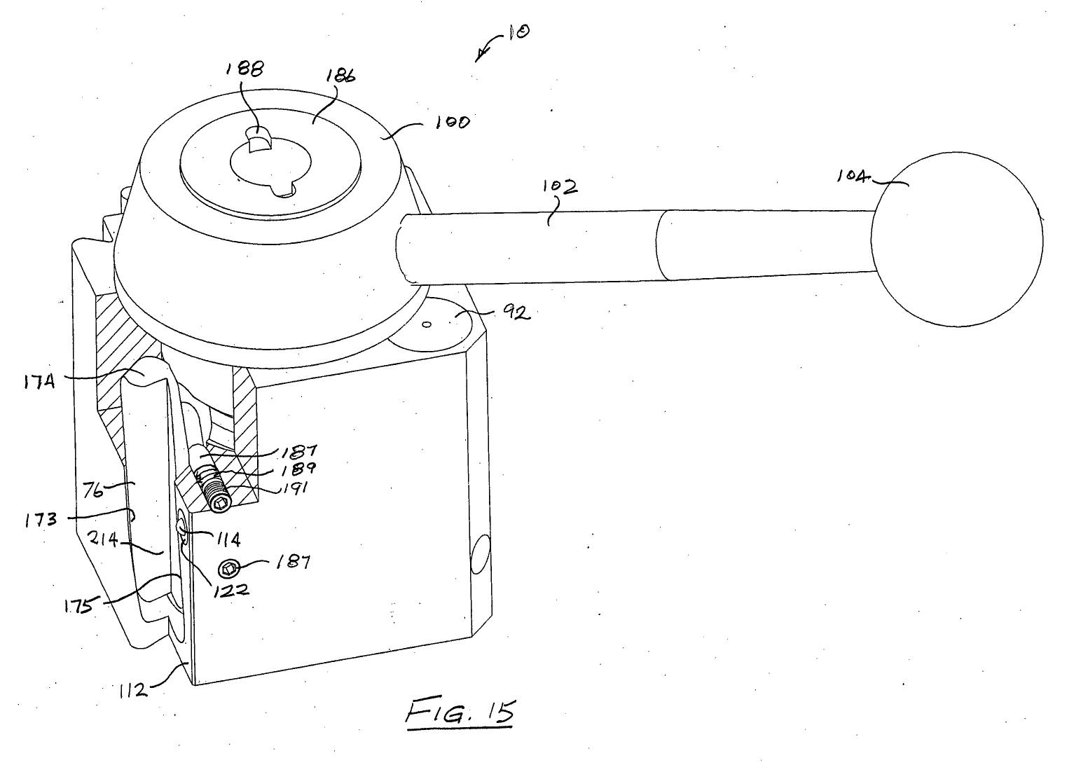

The alternative embodiment of FIG. 19 is shown merely for the purpose of ensuring that the quick-setting indexing and coolant distributing machine tool post of the present is applicable for use in association with a wide variety of machine tool systems from a wide variety of manufacturers. The tool post mechanism is shown with like reference numerals representing like parts as compared with FIGS. 1-18. The tool post body 12 is shown to have a coolant fluid supply fitting 234 which is threaded into an internally threaded opening 236 that is in fluid communication with the internal lateral coolant distribution passage 48 of FIG. 5. An armored coolant fluid distribution line 238 extends to a region near a replaceable cutter insert 240 that is supported by a standard machine tool 242, not having coolant supply or distribution passages. The machine tool 242 is secured in conventional fashion within a tool receptacle 244 of a conventional tool holder 246. The pivotally connected armored sections of the coolant fluid distribution line 238 have sufficient frictional relation that the line can be formed to a particular configuration that will be maintained until it is subsequently changed. The coolant fluid distribution line 238 is provided with a nozzle 248 that directs a jet of coolant fluid immediately to the machining interface of the metal cutting insert 240 with a rotating or otherwise moving workpiece.

If desired, the coolant flow control valves 56 and 58 may be removed and the passages may be plugged when tool holders without coolant fluid supply circuits are used. However, though the coolant flow control valves may be maintained open by engagement of the valve balls by the planar surfaces of the tool holder, the planar surface will establish surface to surface sealing that will prevent leakage of coolant fluid from the open valves.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A quick-setting indexing tool post mechanism, comprising:
a tool post body adapted to be secured to a machine tool bed and defining a first dove tail mount for support of a tool holder having a corresponding second dove-tail mount, said tool post body defining an actuator receptacle and a gib opening in communication with said actuator receptacle, said gib openings being defined in part by a gib guide surface;
a gib member being positioned for movement within said gib opening and in guided relation with said gib guide surface, said gib having a tapered surface and being moveable to a locking position locking said first and second dove-tail mounts against relative movement and to a release position allowing relative movement of said first and second dove-tail mounts; and
a rotatable gib drive member being supported for rotation within said actuator receptacle and having an external thread having angulated thread flanks, said gib member having engagement with said angulated thread flanks and upon rotation of said rotatable gib drive member in a locking direction moving said gib in linear and lateral directions toward said locking position causing locking expansion of said first dove-tail mount and securing said first and second dove-tail mounts against relative movement, upon rotation of said rotatable gib drive member in an unlocking direction moving said gib linearly to said release position collapsing said first dove-tail mount and releasing the tool holder for movement relative to said first dove-tail mount.

2. The quick-setting tool post mechanism of claim 1, comprising:
said thread flanks reacting with said gib during rotational movement of said rotatable gib drive member and imparting downward and lateral force vectors to said gib; and
upon resistance of said gib to linear movement said lateral force vector becoming paramount and applying lateral locking force to said gib.

3. The quick-setting and release tool post mechanism of claim 1, comprising:
said tool post body defining a generally planar reference surface;
said tapered cam surface of said gib member having an included angle α with respect to said generally planar reference surface;
said gib guide surface having an included angle β with respect to the generally planar reference surface; and
said included angle α being greater than said included angle β.

4. The quick setting and release tool post mechanism of claim 1, comprising:
said gib member having a pair of spaced thread flank engaging members each defining a pair of oppositely tapered thread flank engaging surfaces being in simultaneous engagement with said diverging thread flanks; and
rotational movement of said rotatable gib drive member in either of said locking and unlocking directions causing substantially simultaneous force vector application to said gib.

5. The quick setting and release tool post mechanism of claim 1, comprising:
a coolant fluid inlet and coolant supply passage circuit being defined within said tool post body;
at least one coolant flow control member being provided within said coolant supply passage circuit and each having an open condition permitting the flow of coolant within said coolant supply passage circuit and a closed position preventing the flow of coolant within said coolant supply passage circuit; and
a rotary actuator member having driving engagement with said gib drive member and operating said coolant flow control member to said open and closed conditions.

6. The quick setting and release tool post mechanism of claim 1, comprising:
a coolant inlet and coolant supply passage circuit being defined within said tool post body and having a passage portion extending to said dove-tail mount;
flow control valve members being provided within said coolant inlet and said coolant supply passage circuit and each having an open condition and a closed condition; and
a rotary tool post actuator member having rotary driving engagement with said gib drive member and having valve operating relation with said coolant flow control valve member of said coolant inlet.

7. The quick setting and release tool post mechanism of claim 1, comprising:
a tool holder having a coolant entry and having an internal coolant supply passage; and
said coolant entry being located to receive coolant flow from said flow control valve member of said coolant supply passage circuit.

8. The quick setting and release tool post mechanism of claim 7, comprising:
said flow control valve member being a check valve having a moveable normally closed valve element positioned for engagement by said tool holder;
said coolant entry being an elongate slot having communication with said coolant flow control valve element of said flow control valve member within said coolant supply passage circuit at all positions of said tool holder relative to said tool post body; and
said tool holder having a surface engaging and opening said control valve element when said tool holder is assembled and locked to said tool post body.

9. The rotatable quick setting and release tool post mechanism of claim 1, comprising:
said flow control valve member being a check valve positioned within said coolant inlet and having a moveable valve element being normally closed;
a valve actuator mechanism being moveable within said tool post body and having a valve actuator member;
said tool post actuator member having at least one actuating surface disposed for actuating contact with said valve actuator member and moving said actuator member to a valve opening position responsive to selective rotary positioning of said tool post actuator member.

10. The rotatable quick setting and release tool post mechanism of claim 1, comprising:
a tool holder having an internal coolant supply passage therein and having a holder dove-tail mount adapted for supported engagement with a dove-tail mount of said tool post body; and
a coolant supply receiving pressurized coolant from a machining system and having connection with said internal coolant supply passage of said tool holder.

11. A quick-setting and release tool post mechanism, comprising:
a tool post body adapted to be secured to a machine tool bed and having a plurality of external dove-tail mounts;
tool holders being provided for each of said external dove-tail mounts and having corresponding internal dove-tail mounts, said tool post body defining an actuator receptacle and a gib opening through said tool post body and in communication with said actuator receptacle for each of said external dove-tail mounts, said gib openings each being defined in part by at least one gib guide surface;
gib members being positioned for movement within each of said gib openings and in guided relation with said at least one gib guide surface, said gib members having a tapered surface and being linearly moveable to a locking position locking said external and internal dove-tail mounts against relative movement and moveable to a release position allowing relative movement of said dove-tail mounts;
a rotatable gib drive member being supported for rotation within said actuator receptacle and having an external thread having angulated thread flanks, each of said gibs having engagement with said angulated thread flanks, upon rotation of said gib drive member in a locking direction said external thread moving said gibs linearly downward to said locking position causing locking expansion of said external dove-tail mounts and securing said tool holders against movement relative to said tool post body, upon rotation of said gib drive member in an unlocking direction said external thread moving said gibs linearly upward to said release position, releasing said tool holder for movement relative to said tool post body; and
a rotatable tool post actuator having driving relation with said gib drive member and being rotatably moveable for imparting directional rotation to said gib drive member.

12. The quick-setting and release tool post mechanism of claim 11, comprising:
said tool post body defining a reference surface;
said tapered cam surface of said gib member having an included angle α with respect to said generally planar reference surface;
said gib guide surface having an included angle β with respect to the reference surface; and
said included angle α being greater than said included angle β.

13. The quick-setting and release tool post mechanism of claim 11, comprising:
said gibs each having a pair of spaced thread flank engaging members each defining oppositely tapered thread flank engaging surfaces being in simultaneous engagement with said angulated thread flanks; and
rotational movement of said rotatable quick setting and release actuator in either of said first and second directions causing substantially simultaneous linear movement of each of said gibs for substantially simultaneous locking or release of said tool holders from said external dove-tail mounts.

14. The quick-setting and release tool post mechanism of claim 11, comprising:
threaded adjustment posts being mounted to each of said tool holders; and
rotary adjustment members being threaded to said adjustment posts and having positioning engagement with respective external dove-tail mounts and maintaining said tool holders at selected positions relative to said external dove-tail mounts in absence of tool post locking.

15. The rotatable quick setting and release tool post mechanism of claim 11, comprising:
a coolant fluid inlet and coolant supply passage circuit being defined within said tool post body; and
a coolant flow control valve member being provided within said coolant supply passage circuit and each having an open condition permitting the flow of coolant within said coolant supply passage circuit and a closed position preventing the flow of coolant within said coolant supply passage circuit; and.
said rotary tool post actuator member operating said valve member to said open position responsive to tool post actuating rotation thereof.

16. The rotatable quick setting and release tool post mechanism of claim 11, comprising:
coolant fluid inlet and coolant supply passage circuits being defined within said tool post body and having a passage portions extending to each of said external dove-tail mounts;
coolant flow control valve members being provided within said coolant fluid inlet and said supply passage circuits and each having an open condition and a closed condition;
said rotary tool post actuator member having valve operating relation with said coolant flow control member of said inlet; and
said tool holders, when assembled to said tool post body, moving said flow control valve members of said supply passage circuits to said open condition permitting the flow of coolant from said tool post body to said coolant distribution circuits of said tool holders.

17. The rotatable quick setting and release tool post mechanism of claim 11, comprising:
each of said tool holders having a coolant entry and having an internal coolant supply passage therein; and
said coolant entry being located to receive coolant flow from one of said supply passage circuits upon opening of said coolant flow control valve members.

18. The rotatable quick setting and release tool post mechanism of claim 17, comprising:
said coolant flow control valve members of said coolant supply passage circuits being check valves having a moveable valve element being normally closed and being positioned for engagement by a respective one of said tool holders;
said coolant entry being an elongate slot having communication with said second coolant flow control valve member at all positions of said tool holder relative to said tool post body; and
said tool holders each having a surface engaging and opening said check valve member when said tool holder is assembled and locked to said tool post body.

19. The rotatable quick setting and release tool post mechanism of claim 11, comprising:
said first coolant flow control valve member being a check valve positioned within said coolant inlet and having a moveable valve element being normally closed;
a valve actuator mechanism being moveable within said tool post body and having an actuator member;
said tool post actuator member having at least one actuating surface disposed for actuating contact with said actuator member and moving said actuator member to a valve opening position responsive to selective rotary positioning of said tool post actuator member.

20. A quick-setting and release tool post mechanism, comprising:
a tool post body adapted to be secured to a machining system and having a plurality of external dove-tail mounts;
tool holders being provided for each of said external dove-tail mounts and having corresponding internal dove-tail mounts, said tool post body defining an actuator receptacle and a gib opening through said tool post body and in communication with said actuator receptacle for each of said external dove-tail mounts, said gib openings each being defined in part by at least one gib guide surface;
a gib being positioned for movement within each of said gib openings and in guided relation with said at least one gib guide surface, said at least one gib having a tapered surface and being linearly moveable to a locking position locking said external and internal dove-tail mounts against relative movement and moveable to a release position allowing relative movement of said first and second dove-tail mounts;
a rotatable quick setting and release actuator being supported for rotation within said actuator receptacle and having an external thread having diverging thread flanks, each of said gibs having engagement with said diverging thread flanks, upon rotation of said rotatable quick setting and release actuator in a first direction moving said gibs linearly downward to said locking position causing locking expansion of said external dove-tail mounts and securing said tool holders against movement relative to said tool post body, upon rotation of said rotatable quick setting and release actuator in a second direction moving said gibs linearly upward to said release position, releasing said tool holder for movement relative to said tool post body; and
a rotatable tool post actuator having driving relation with said rotatable quick setting and release actuator and being rotatably moveable for imparting directional rotation to said rotatable quick setting and release actuator;
coolant fluid inlet and coolant supply passage circuits being defined within said tool post body and having a passage portions extending to each of said external dove-tail mounts;
coolant flow control valve members being provided within said coolant fluid inlet and said supply passage circuits and each having an open condition and a closed condition;
said rotary tool post actuator member having valve operating relation with said coolant flow control member of said inlet; and
said tool holders, when assembled to said tool post body, moving said flow control valve members of said supply passage circuits to said open condition permitting the flow of coolant from said tool post body to said coolant distribution circuits of said tool holders.

21. The rotatable quick setting and release tool post mechanism of claim 20, comprising:
said coolant flow control valve members of said coolant supply passage circuits being check valves having a moveable valve element being normally closed and being positioned for engagement by a respective one of said tool holders;
said coolant entry being an elongate slot having communication with said second coolant flow control valve member at all positions of said tool holder relative to said tool post body; and
said tool holders each having a surface engaging and opening said check valve member when said tool holder is assembled and locked to said tool post body.

22. A coolant distributing tool post mechanism, comprising:
a tool post body;
a coolant inlet being defined by said tool post body;
a coolant outlet being defined by said tool post body;
a coolant passage circuit being defined within said tool post body and being in fluid communication with said coolant inlet and said coolant outlet.

23. A coolant distributing tool holder, comprising
a tool holder member defining a tool receptacle adapted to receive and secure a machine tool;
locking members being mounted to said tool holder body and being adjustable to secure a machine tool within said tool receptacle;
coolant passages being defined within said tool holder member and having a coolant inlet;
and a coolant outlet.

24. A method for machining employing a quick-setting coolant supplying tool post mechanism having a tool post body having an internal coolant passage system, comprising:
conducting an inlet flow of pressurized coolant from a coolant pump of a machining system to said internal coolant passage system of said tool post body;
conducting a flow of pressurized coolant from said internal coolant passage system of said tool post body to a coolant passage system of a tool holder mounted to said tool post body; and
selectively controlling the flow of coolant within said internal coolant passage system of said tool post body to said internal coolant passage system of said tool holder.

25. The method of claim 24, comprising:
moving a rotary actuator of said tool post mechanism to locking and release positions; and
selectively controlling the flow of coolant within said internal coolant passage system with valves responsive to positioning of said rotary actuator.

26. The method of claim 25 wherein outlet valves control outlet of coolant flow from said internal coolant passage system of said tool post mechanism, comprising:
positioning a tool holder mechanism in assembly with said tool post mechanism, said tool holder mechanism having an internal coolant passage system therein; and
moving said tool holder mechanism during locking thereof to a position opening said outlet valves and permitting flow of coolant from said internal passage system of said tool post mechanism to said internal coolant passage system of said tool holder.

27. A method of locking and unlocking a tool holder with respect to a tool post mechanism having a rotatable gib drive member defining an external thread having angulated thread flanks and a gib member being actuated for linear and lateral movement to a locking position securing the tool holder to said tool post body and a releasing position permitting movement of said tool holder with respect to said tool post mechanism, comprising:
rotating said rotary externally threaded gib drive member in a locking direction causing thread induced linear movement of said gib member toward said locking position causing a tapered cam surface of said gib member to move said gib member toward said locking position and causing thread flank induced development of downward and lateral forces on said gib member locking said tool holder at a selected position relative to said tool post mechanism; and
rotating said gib drive member in an unlocking direction causing unlocking movement of said gib member.
